(19) United States
(12) Patent Application Publication
(10) Pub. No.: US 2013/0154607 A1
(43) Pub. Date: Jun. 20, 2013

(54) REACTIVE REGULATOR

(71) Applicant: Paulo Rogerio Granja, Birigui-SP (BR)

(72) Inventor: Paulo Rogerio Granja, Birigui-SP (BR)

(73) Assignee: ITB EQUIPAMENTOS ELETRICOS LTDA, Birigui - SP (BR)

(21) Appl. No.: 13/331,391

(22) Filed: Dec. 20, 2011

(51) Int. Cl. H02J 3/00

(52) U.S. Cl. 323/361; 323/355

(57) ABSTRACT

A Reactive regulator capable of introducing reactive powers in an AC electrical system in order to satisfy the reactive power demanded by the loads of such electrical system in a gradual way, when demanded, and in as many stages as necessary to improve the efficiency and viability of such electrical system by having ways to vary the voltage on one or more reactive elements through a coupling element, transformer, autotransformer or any other type of variable voltage drive, whose primary is connected to an electrical system through terminals and the secondary is connected to a reactive element through at least one switch, of solid state or not, which allows the connection of a mobile terminal to any of the derivations of the secondary of the coupling device.

### FIELD OF THE INVENTION

The present invention is in the field of AC electrical systems.

### BACKGROUND OF THE INVENTION

The methods currently used for correcting reactive loads are composed of specific elements, inductors or capacitors, which are inserted into the system in a permanent or optional way. In a permanent way the reactive elements are fixed in the system and can only be removed through a local operation. In an optional way the same loads are connected by switches that allow the activation through electrical, manual or automatic control, locally or remotely.

Even using the most flexible of these two ways of introducing reactive loads (the optional way) the number of load stages is very limited for most applications (only two stages) with or without reactive loads. Thus, it is not very adapted to the network seasonality and, to increase its flexibility, it would be necessary to introduce more stages, i.e. more loads and more switches to control its insertions and removals, requiring expensive standby equipment and significantly increasing the cost of the electrical systems, the more the higher the system voltage.

What is needed therefore is a device capable of introducing reactive power in an AC electrical system in order to gradually provide the reactive power required by the loads of this electrical system, in case of demand, and in as many stages as needed to improve the efficiency and viability of the whole system. The introduction of these reactive powers done automatically or manually, as well as locally or remotely.

### SUMMARY OF THE INVENTION

The present invention seeks to provide an electric reactive regulator capable of introducing reactive power in an electrical system, the reactive regulator comprising: (a) a transformer or autotransformer, having a primary coupling (2) connected to the electrical system through a first terminal (1) and a second terminal (3): (b) a reactive element (7): (c) a mobile terminal (6), and (d) a secondary coupling (4) having multiple derivations (5): the secondary coupling connected to the reactive element (7) through at least one switch, selected from the group consisting of: solid-state and not solid-state; enabling the connection of the mobile terminal (6) to any one of the multiple derivations (5). When varying the voltage applied to the reactive element (7) through a shift of the mobile terminal (6) of the multiple derivations (5) of the secondary coupling (4), the power of the reactive regulator will vary, generating the most appropriate power to the specific electrical system.

### BRIEF DESCRIPTION OF THE DRAWINGS

FIG. 1 shows an electromagnetic diagram of the reactive regulator

### DETAILED DESCRIPTION OF THE INVENTION

To gradually provide reactive loads the reactive regulator of the present invention uses a single reactive element, single or set, capacitor and/or inductor. An example in through derivation of a coupling transformer, applying different voltages on one of these elements, converting them, each one in its own time, in several stages of different powers that can be gradually introduced as needed by the system, manually or automatically.

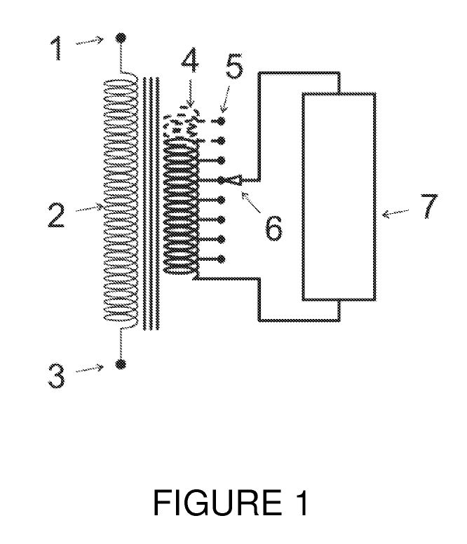

As it can be seen in FIG. 1 the reactive regulator consists of a transformer, or autotransformer, whose primary coupling (2) is connected to the electrical system through the terminals (1) and (3) and the secondary coupling (4) is connected to the reactive element (7) through at least one switch, of solid state or not, which allows the connection of the mobile terminal (6) to any one of the derivations (5) of the secondary coupling transformer.

As the power of the reactive element (7) is defined as the division of the square of the voltage applied to the reactive element (7) by the impedance of the reactive element (7), when varying the voltage applied to the reactive element (7) through the shift of the mobile terminal (6) among the various derivations (5) of the secondary of the coupling transformer, the power of the reactive regulator will vary, generating the most appropriate power to the specific electrical system.

The reactive regulator can be built in a way to satisfy several voltage levels in several power ranges, also with several numbers of stages or steps, in order to satisfy any demand of an AC electrical system and its seasonality. The reactive regulator can also be built in a single-phase or poly-phase way, and in any configuration of connection, such as: star or delta.

Sensor elements and control devices may be incorporated to the regulator, which allow monitoring the electrical system, in order to automatically adjust itself to the demand of the electrical system. Protective elements to prevent overvoltage, overcurrent and voltage and/or current peaks of any kind may also be optionally incorporated.

The components may be built into the reactive reactor as a unitary assembly, as a single-phase or as a poly-phase, as well as can be built through an electrical interconnection of its components supplied by a sole manufacturer or by different manufacturers.

The reactive regulator can be prepared to receive different reactive elements, inductive or capacitive, additional or interchangeable, for series or parallel operation, in a reconnectable way to operate at different voltages. The components may also be electrically isolated by solid, liquid or gaseous means, with natural or forced cooling, by any kind of environment or hermetic fluid.

The regulator may be built with inductive and capacitive reactive element and may include ways to select the most appropriate one to each moment of the electrical system in which it is connected. Also, the reactive regulator is built in a manner that enables its operation in any condition of application, temperature, pressure and other environmental conditions.

It should be understood that the preferred embodiments mentioned here are merely illustrative of the present invention. Numerous variations in design and use of the present invention may be contemplated in view of the following claims without straying from the intended scope and field of the invention herein disclosed.

1. An electric reactive regulator capable of introducing reactive power in an electrical system, the reactive regulator comprising:
(a) a transformer or autotransformer, having a primary coupling (2) connected to the electrical system through a first terminal (1) and a second terminal (3):
(b) a reactive element (7);
(c) a mobile terminal (6), and
(d) a secondary coupling (4) having multiple derivations (5); the secondary coupling connected to the reactive element (7) through at least one switch, selected from the group consisting of: solid-state and not solid-state; enabling the connection of the mobile terminal (6) to any one of the multiple derivations (5),
wherein, when varying the voltage applied to the reactive element (7) through a shift of the mobile terminal (6) of the multiple derivations (5) of the secondary coupling (4), the power of the reactive regulator will also vary, generating the most appropriate power to the specific electrical system.

2. The electric reactive regulator according to claim 1, wherein the power of the reactive element (7) is defined as a division of the square of the voltage applied to the reactive element (7) by the impedance of the reactive element (7).

3. The electric reactive regulator according to claim 1, wherein the electrical system is an AC electrical system.

4. The electric reactive regulator according to claim 1, wherein the reactive element is a mono-phase reactive element and the transformer is a mono-phase coupling transformer. capable of varying the voltage on the reactive elements.

5. The electric reactive regulator according to claim 1, wherein reactive element is a mono-phase reactive element and the transformer is a coupling autotransformer, capable of varying the voltage on the reactive elements.

6. The electric reactive regulator according to claim 1, wherein the reactive element is a three-phase reactive element and the transformer is selected from the group consisting of: a three-phase coupling transformer and a set of single-phase transformers capable of varying the voltage on the reactive elements, jointly or individually.

7. The electric reactive regulator according to claim 1, wherein the reactive element is a three-phase reactive element and the autotransformer is selected from the group consisting of: a three-phase coupling auto transformer and a set of single-phase autotransformers; capable of varying the voltage on the reactive elements, jointly or individually.
